(19) United States
(12) Patent Application Publication
(10) Pub. No.: US 2024/0004385 A1
(43) Pub. Date: Jan. 4, 2024

(54) SYSTEMS AND METHODS FOR ACCESSORY MANAGEMENT

(71) Applicant: APPLE INC., Cupertino, CA (US)

(72) Inventors: Jonathan P. Gardner, Austin, TX (US); Thaddeus S. Fortenberry, Dripping Springs, TX (US)

(21) Appl. No.: 18/216,400

(22) Filed: Jun. 29, 2023

Related U.S. Application Data
(60) Provisional application No. 63/356,791, filed on Jun. 29, 2022.
(60) Provisional application No. 63/356,799, filed on Jun. 29, 2022.

(51) Int. Cl. G05D 1/00; G05D 1/02

(52) U.S. Cl. CPC G05D 1/0088; G05D 1/0022; G05D 1/0212; G05D 1/0016

(57) ABSTRACT

Implementations described and claimed herein provide systems and methods for accessory management. In some implementations, one or more sensors are configured to capture accessory data corresponding to a mobile device accessory. A monitoring system is configured to identify an event affecting at least one of mobile device operation of a mobile device or accessory operation of the mobile device accessory by comparing a first accessory state for the mobile device accessory to a second accessory state for the mobile device accessory. The monitoring system determines a response to the event.

### CROSS-REFERENCE TO RELATED APPLICATIONS

The present application claims priority to U.S. Provisional Application No. 63/356,799 filed on Jun. 29, 2022 and to U.S. Provisional Application No. 63/356,791 filed on Jun. 29, 2022. Each of these applications is incorporated by reference in its entirety herein.

### FIELD

Aspects of the present disclosure relate to systems and methods for accessory management and more particularly to managing mobile device accessories for a mobile device and/or monitoring an accessory of a mobile device.

### BACKGROUND

A mobile device accessory may be used with a mobile device for a variety of purposes. Various conditions may arise that affect an operation of the mobile device and/or the mobile device accessory. However, during operation of the mobile device, it is often challenging to timely identify and respond to such conditions. Additionally, adjusting the operation of the mobile device after use is initiated often creates latency concerns, among other issues. Moreover, it is challenging to predict how a particular mobile device accessory may affect the operation of a particular mobile device.

### SUMMARY

Implementations described and claimed herein address the foregoing by providing systems and methods for mobile device accessory management. In some implementations, a mobile device accessory is identified. An attachment state of the mobile device accessory relative to the mobile device is determined. An operation of the mobile device is controlled according to the attachment state of the mobile device accessory, and the operation of the mobile device is adjusted based on an accessory profile corresponding to the mobile device accessory.

In some implementations, a mobile device accessory is identified. An attachment state of the mobile device accessory relative to the mobile device is determined. An operation of the mobile device is adjusted based on an accessory profile when the attachment state is identified as attached. The accessory profile corresponds to the mobile device accessory. Adjustment of the operation of the mobile device is forgone when the attachment state is identified as unattached.

In some implementations, an accessory management system is configured to determine an attachment state of a mobile device accessory relative to a mobile device. A control system is configured to control an operation of the mobile device based on the attachment state of the mobile device accessory. The operation of the mobile device is adjusted based on an accessory profile corresponding to the mobile device accessory.

In some implementations, a first accessory state for a mobile device accessory is obtained. The first accessory state corresponds to an expected behavior of the mobile device accessory. Accessory data corresponding to the mobile device accessory is obtained. A second accessory state of the mobile device accessory is determined based on the accessory data. The second accessory state corresponding to a behavior of the mobile device accessory. An event affecting at least one of mobile device operation of a mobile device or accessory operation of the mobile device accessory by comparing the expected behavior of the mobile device accessory to the behavior of the mobile device accessory. A response to the event is determined.

In some implementations, one or more sensors are configured to capture accessory data corresponding to a mobile device accessory. A monitoring system is configured to identify an event affecting at least one of mobile device operation of a mobile device or accessory operation of the mobile device accessory by comparing a first accessory state for the mobile device accessory to a second accessory state for the mobile device accessory. The monitoring system determines a response to the event.

Other implementations are also described and recited herein. Further, while multiple implementations are disclosed, still other implementations of the presently disclosed technology will become apparent to those skilled in the art from the following detailed description, which shows and describes illustrative implementations of the presently disclosed technology. As will be realized, the presently disclosed technology is capable of modifications in various aspects, all without departing from the spirit and scope of the presently disclosed technology. Accordingly, the drawings and detailed description are to be regarded as illustrative in nature and not limiting.

### BRIEF DESCRIPTION OF THE DRAWINGS

FIG. 1 illustrates an example environment for mobile device accessory management.

FIG. 2 illustrates an example environment for mobile device accessory monitoring.

FIG. 3 illustrates an example mobile device.

FIG. 4 illustrates example operations for mobile device accessory management.

FIG. 5 illustrates other example operations for mobile device accessory management.

FIG. 6 illustrates other example operations for mobile device accessory management.

FIG. 7 is an example computing system that may implement various aspects of the presently disclosed technology.

### DETAILED DESCRIPTION

Aspects of the presently disclosed technology relate to systems and methods for mobile device accessory management. In one aspect, systems and methods proactively and dynamically adjusting operation of a mobile device based on a mobile device accessory. Different mobile device accessories may affect the operation of the mobile device in various manners. Additionally, operation of a first mobile device may be affected by a mobile device accessory differently than a second mobile device. For example, a mobile device accessory may be attachable to a mobile device configured to move from a first location towards a second location. The systems and methods discussed herein determine an overall device configuration of the mobile device, as modified by the mobile device accessory, and control the operation of the mobile device in association with the movement based on the overall device configuration. In some aspects, a mobile device accessory is identified, which may include identifying a presence of the mobile device accessory in a vicinity of the mobile device and obtaining an accessory profile for the mobile device accessory. For example, the accessory profile may be obtained using a visual identifier (e.g., a quick response (QR) code), a transmitted identifier, and/or the like. An attachment state of the mobile device accessory relative to the mobile device may be determined. When the attachment state of mobile device accessory is identified as attached, operation of the mobile device may be adjusted or otherwise controlled based on the accessory profile, and when the attachment state of the mobile device accessory is identified as unattached, the operation of the mobile device is unadjusted. Accordingly, operation of a particular mobile device is dynamically controlled based on an accessory profile and an attachment state of a particular mobile device accessory.

In another aspect, systems and methods monitor a mobile device accessory and dynamically adjusting operation of a mobile device based on the state of a mobile device accessory. In some examples, a mobile device accessory is attachable to a mobile device configured to move along a movement path from a first location towards a second location. In connection with the movement, the mobile device accessory may experience an event affecting an operation of the mobile device accessory, affecting an operation of the mobile device, and/or otherwise being an irregular event relative to expectations. The event is identified based on a comparison of a first accessory state with a second accessory state, and a response to the event is determined accordingly. Generally, the presently disclosed technology observes a behavior associated with the mobile device accessory and determines any changes in the behavior of the accessory. An observation of change in accessory state of the mobile device accessory combined with analysis of the change may be used to identify an event and determine one or more responses. In some instances, the monitoring and responses may be performed entirely by the mobile device. Overall, the presently disclosed technology timely identifies and responds to events affecting the mobile device, the mobile device accessory, and/or other objects (e.g., other mobile devices) along a movement path.

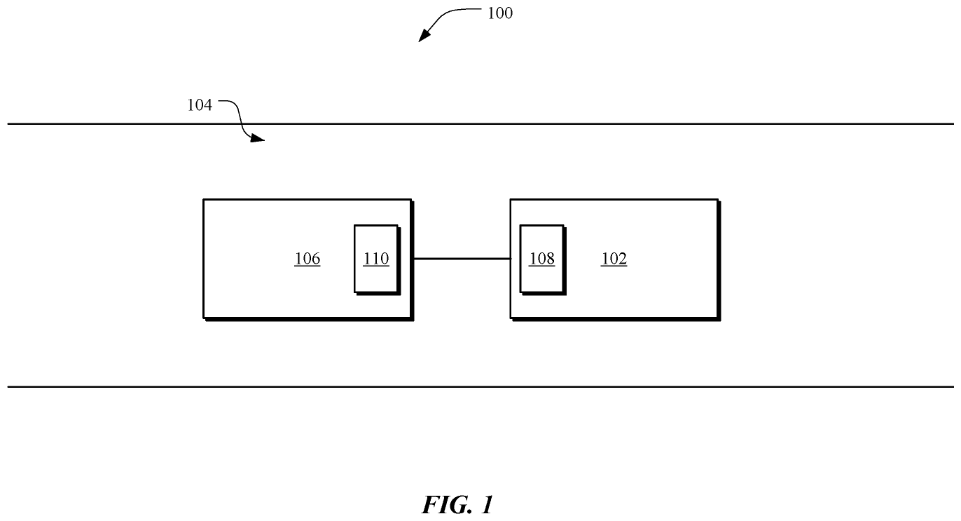

To begin a detailed description of an example environment 100 for mobile device accessory management, reference is made to FIG. 1. In one implementation, a mobile device 102 is configured to move along a travel path 104 (e.g., a route, movement trajectory, etc.) from a first location (e.g., an origin) towards a second location (e.g., a destination). In one example, the mobile device 102 may be capable of operating to move along the travel path 104 with limited input from a person, such as occupants within an interior of the mobile device 102. Stated differently, rather than a person having an operational engagement with the mobile device 102 to control its actions, the person may simply input a destination point or other instruction and the mobile device 102 transports the occupant to the destination point along the route through a series of decisions made and taken by the mobile device 102. Using localization data, a current geographical position of the mobile device 102 within a geographical area and/or relative to the destination or other location may be determined. Using the localization data, the route from the current geographical position to the destination may be generated, a position along the route may be determined, and/or the like. Additionally, depending on their nature and movement, one or more objects present in a scene along the travel path 104 may or may not affect the actions being executed by the mobile device 102 as it moves through the scene. In one implementation, the mobile device 102 regularly captures sensor data of the scene to generate perception data providing a perception of the scene, which may include, without limitation, object recognition of the one or more objects present in the scene. The object recognition may include detection, identification, classification, localization, and/or the like of the one or more objects present in the scene. Using the localization data and the perception data, the mobile device 102 moves along the travel path 104 through the scene in accordance with its perception, as well as its motion and route planning.

One or more mobile device accessories 106 may be used in connection with the mobile device 104. In some examples, the mobile device accessory 106 is attachable to the mobile device 104, thereby transporting the mobile device accessory 106 along the travel path 104 with the mobile device 102. The mobile device accessory 106 may be attached to the mobile device 102 in various manners, such as using a connection system, including, without limitation, a hitch, rack(s), mount(s), strap(s), cable(s), clip(s), chain(s), and/or the like. The mobile device accessory 106 may be releasably attached or fixed to the mobile device 102 using the connection system. Once attached, the mobile device accessory 106 may be positioned: at a top, front, back, side, bottom, bed, and/or surface of the mobile device 104; on, adjacent, and/or at a distance from the mobile device 104; and/or otherwise relative to the mobile device 104. In this manner, the mobile device accessory 106 may be hauled, pushed, pulled, carried, or otherwise transported by the mobile device 102. The mobile device 102 may be a vehicle, robot, and/or the like and the mobile device accessories 106 may include, without limitation, trailers, racks, vehicles, carriers, platforms, mounts, and/or the like. The mobile device accessory 106 may further be configured to connect with, mount, hold, and/or otherwise transport a load including additional objects. As such, the mobile device accessory 106 may have one or more accessory states, such as loaded, unloaded, partially loaded, and/or the like, as well as one or more attachment states, such as attached, unattached, partially attached, improperly attached, and/or the like.

The mobile device accessory 106 may change one or more characteristics of the mobile device 102, including, but not limited to, size (e.g., width, height, length, and/or other dimensions), weight (e.g., overall weight, distribution of weight, center of gravity, etc.), clearance (e.g., vertical, horizontal, lengthwise, etc.), sensor field of view, visibility, number of axels, and/or the like. Such changes to the characteristics of the mobile device 102 may affect the operation of the mobile device 102, including, without limitation, aerodynamics, movement dynamics (e.g., parking, reversing, movement path towards a target, acceleration, deceleration, etc.), traction control, turning (e.g., turning speed, turning radius, etc.), stopping distance, braking characteristics, gear shifting, blind spot management, sensor alarm activation (e.g., deactivating a proximity alarm, backup sensor, etc.), external vision, navigation, clearance management (e.g., routing based on clearance, lane changes based on clearance, etc.), and/or the like. The characteristics and the associated effect on the operation of the mobile device 102 may vary depending on a type of the mobile device accessory 106, characteristics of the type of the mobile device accessory 106, the accessory state of the mobile device accessory 106, the attachment state of the mobile device accessory 106, and/or the like. Stated differently, each of the mobile device accessories 106 may be different and affect the characteristics and the operation of the mobile device 102 in various ways, which may further vary depending on the particular characteristics of the mobile device 102 compared with other mobile devices. As such, an accessory management system 108 is configured to identify a particular mobile device accessory (the mobile device accessory 106) and control an operation of a particular mobile device (the mobile device 102) accordingly.

The accessory management system 108 may be associated with the mobile device 102. For example, the accessory management system 108 may form part of the mobile device 102, part of a user device associated with a user of the mobile device 102 and in communication with the mobile device 102, a computing device removably deployed and in communication with the mobile device 102, and/or the like. In one implementation, identifying the mobile device accessory 106 includes identifying a presence of the mobile device accessory 106 and obtaining an accessory profile 110 associated with the mobile device accessory 106. The presence of the mobile device accessory 106 may be identified based on a detection of an accessory identifier, detection of an object in a vicinity of the mobile device 102, user input, establishment of a connection (e.g., wired and/or wireless connection) between the mobile device accessory 106 and the mobile device 102 (e.g., through pairing), detection of an attachment of the mobile device accessory 106 to the mobile device 102, and/or in other manners. The accessory identifier may be a visual identifier, a transmitted identifier, and/or other identifiers. The accessory profile 110 may be obtained by the accessory management system 108 using the accessory identifier.

For example, the visual identifier may be a QR code, barcode, pattern, branding (e.g., manufacturer name, manufacturer logo, model name/number, etc.), graphics, words, numbers, and/or other unique visual elements. The visual identifier may be scanned, read, and/or captured using an imaging device of the mobile device 102, a user device, or other computing device, causing the accessory profile 110 to be obtained. For example, an accessory registry may store a plurality of accessory profiles corresponding to specific mobile device accessories. The accessory registry may be stored in local memory of the mobile device 102, the user device, or other computing device or in a database accessible over a network. Using the visual identifier, the accessory profile 110 may be obtained from the accessory registry. In another example, the visual identifier launches a webpage or application containing the accessory profile 110. The transmitted identifier may be, without limitation, radio frequency identification (RFID), near-field communication (NFC), chip, identifying information communicated via a wired or wireless connection (e.g., wireless radio transmission), etc. The transmitted identifier may similarly provide or cause the accessory profile 110 to be obtained. Other identifiers may include, for example, user input providing and/or causing the accessory profile 110 to be obtained.

In one implementation, the accessory profile 110 includes one or more specifications of the mobile device accessory 106. The specifications may include size, shape, weight, attachment systems, operational parameters, number of axels, hitch to axel dimensions, and/or other parameters that may define changes to characteristics of the mobile device 102 in a manner that may affect operations of the mobile device 102. The specifications may be provided by a manufacturer of the mobile device accessory 106, user input, accessory data, and/or other obtained via other sources. For example, an operation manual provided by the manufacturer may detail the one or more specifications. In another example, the specifications are defined through user input in generating a customized accessory profile. The accessory identifier may be generated and correlated with the specifications provided by the user. A webpage, application, and/or the like may generate a QR code, for example, and provide an interface for capturing the corresponding specifications to generate a customized accessory identifier and customized accessory profile. The QR code may be positioned on the mobile device accessory 106, such that it may be scanned by a sensor of the mobile device 102, a user device associated with the user, and/or the like.

The accessory profile 110 may be obtained based on accessory data captured using one or more sensors, such as LIDAR. The accessory data may be used to generate the accessory profile 110 by estimating a type of the mobile device accessory 106, as well as the specifications. For example, the accessory data may be compared with a plurality of object models to identify a match for the mobile device accessory 106. Based on the match, the accessory profile 110 is provided. Where no match exists, the user may be prompted to provide the specifications for the mobile device accessory 106. The user may be similarly prompted to confirm or adjust the estimated type and specifications of the mobile device accessory 106. In another example, the accessory management system 108 may detect the visual identifier, such as a manufacturer logo or model number, using the accessory data and retrieve the accessory profile 110.

In one implementation, the accessory management system 108 determines the attachment state of the mobile device accessory 106 relative to the mobile device 102 at one or more times. The attachment state may be determined: at an origin location prior to the mobile device 102 moving on its own planning and decisions; while the mobile device 102 moving on its own planning and decisions from the origin location toward the destination location; after arrival at a destination location; while stopping; while moving; and/or the like. As such, the accessory management system 108 may determine if the mobile device accessory 106 is attached, unattached, or partially attached, and if the attachment state of the mobile device accessory 106 changes during movement (e.g., the mobile device accessory 106 becomes inadvertently disengaged). The attachment state may be detected using one or more sensors associated with the mobile device 102, the mobile device accessory 106, and/or other devices.

Based on the attachment state of the mobile device accessory 106, the operation of the mobile device 102 may be controlled. For example, when the mobile device accessory 106 is in the attached state, the operation of the mobile device 102 may be adjusted based on the accessory profile 110. When the mobile device accessory 106 is in the unattached state, the operation of the mobile device 102 is not adjusted based on the accessory profile 110, such that the mobile device 102 operates normally based on the characteristics of the mobile device 102. When the mobile device 106 is in the partially attached state, the operation of the mobile device 102 may be adjusted to transition the mobile device accessory 106 to the attached or unattached state, stop movement of the mobile device 102, generate an alert, and/or the like. In this manner, the accessory management system 108 may identify and respond to attachment state changes.

Additionally, the accessory management system 108 may determine the accessory state of the mobile device accessory 106, such as loaded, unloaded, and/or partially loaded, and control the operation of the mobile device 102 accordingly. Using one or more sensors, user input, and/or the like, the accessory state and accessory state parameters may be determined. The accessory state parameters may include, without limitation, a size of the load, a shape of the load, a total weight of the load, a distribution of weight of the load, an attachment security of the load (e.g., whether the load is tied down or loose), a configuration status of the mobile device accessory 106 (e.g., open door, deflated tire, disconnected lights, etc.), and/or the like. The accessory state and the accessory state parameters may be derived in various manners. For example, based on the specifications for the mobile device accessory 106 obtained from the accessory profile 110, the mobile device accessory 106 has a known weight. As such, when the mobile device 102 initiates movement, additional weight associated with the load and a distribution of weight (e.g., more or less tongue weight) may be detected, from which the accessory state and the accessory state parameters may be estimated. Similarly, known suspension values may be used to determine if a bike rack is loaded and with how many bikes. Using known values for the mobile device 102 and the mobile device accessory 106, the accessory state and the accessory state parameters may be determined and the operation of the mobile device 102 controlled accordingly. Additionally, known configurations of the mobile device accessory 106 may be accounted for in the operation of the mobile device 102. For example, the mobile device accessory 106 may include a swinging gate that the mobile device 102 provides a clearance distance for opening during parking.

Based on the attachment state and accessory state, the operation of the mobile device 102 may be controlled. In one implementation, the operation of the mobile device 102 is controlled based on the accessory profile 110, the accessory state parameters, and/or the like. For example, the operation may include, without limitation, parking, reversing, navigation, movements, acceleration, deceleration, traction control, turning, stopping distance, braking characteristics, gear shifting, blind spot management, sensor alarm activation, vision, clearance management, and/or the like. A visual confirmation may be provided to a user device or presented on a display for the user to validate the accessory profile 110, the attachment state, and the accessory state.

Additionally, controlling the operation of the mobile device 102 may further include controlling accessory operation of the mobile device accessory 106. For example, the accessory management system 108 may detect automated features of the mobile device accessory 106 (e.g., an automated trailer hitch, automated door, brakes, lights, automated sensors, automated actuators, etc.) and control the automated features based on the accessory profile 110, the accessory state parameters, and/or the like. In one implementation, the operation is controlled to automatically move an automated trailer hitch, as well as the mobile device 102 and/or the mobile device accessory 106, to automatically attach and detach the mobile device accessory 106 to and from the mobile device 102 using the automated trailer hitch. The mobile device 102 and the mobile device accessory 106 may be configured in a trusted pairing or authenticated communication, thereby permitting control and sharing of data when the mobile device accessory 106 is in the attached state.

In some examples where the weight of the mobile device 102 as modified by the mobile device accessory 106 changes, acceleration, stopping distance, traction control, turning, braking, gear shifting, and/or the like may be adjusted. In other examples where the size and/or clearance of the mobile device 102 as modified by the mobile device accessory 106 changes, parking, reversing, blind spot management, clearance management, and/or the like may be adjusted. The mobile device 102 may generate a route or movement path based on clearance along the route, conduct lane changes based on an increased length, adjust turning radius, adjust movement based on increased drag or other aerodynamic considerations, adjust movement based on a configuration of the mobile device accessory 106, and/or other operations according to the change in size and/or clearance. For example, reversing operations change when the mobile device 102 is hauling the mobile device accessory 106 (e.g., with a hitch). To reach a target location, such as a parking spot, while reversing with the mobile device accessory 106 in the attached state, the mobile device 102 is moved along a different series of movements, directions, and orientations relative to when the mobile device accessory 106 is in the unattached state. Accordingly, parameters of the parking spot are identified (e.g., size, clearance, orientation, etc.) and the mobile device 102 reverses the mobile device accessory 106 into the parking spot according to the accessory profile 110, the accessory state parameters, and/or the parameters of the parking spot, such that a parking spot may be identified and the mobile device accessory 106 reversed into the parking spot autonomously. In some examples, the mobile device 102 and/or the mobile device accessory 106 may be positioned within the parking spot relative to a charging station.

Similarly, based on size and positioning, the mobile device accessory 106 and/or load may obstruct a field of view of one or more sensors of the mobile device 102 or other visibility, which may trigger false proximity alarms, false backup alarms (e.g., during reversing operations) or result in incomplete perception data. Accordingly, the proximity alarm may be deactivated, external vision may be generated or otherwise provided, and/or the like.

In one implementation, where visibility is obstructed by the mobile device accessory 106 and/or the load, external vision of the unobstructed view is provided. For example, images or video may be captured and transmitted from a sensor of the mobile device accessory 106 to the mobile device 102 for presentation (e.g., on a windshield, window surface, rearview mirror, internal display, user device, heads-up display, and/or the like). In another example, sensors of the mobile device 102 may capture a plurality of images of a scene around the mobile device 102. A composite image may be generated from the plurality of images removing the mobile device accessory 106 from the field of view based on the specifications (e.g., size) of the accessory profile 110. The composite image may be generated through stitching, utilize visual object removal, image replacement, and/or other image processing techniques to provide unobstructed visibility. The composite image may be presented, for example, with a windshield, window surface, rearview mirror, internal display, user device, heads-up display, and/or the like.

In some implementations where the mobile device 102 is deployed in a fleet of mobile devices, the accessory management system 108 may be used to determine the accessory state and the attachment state of the mobile device accessory 106 for customizing a user experience according to user needs. For example, a user may request a pickup from a mobile device including a bike rack. One or more mobile devices having a bike rack may be identified, and the mobile device 102 may be dispatched to a location of the user. The accessory management system 108 may determine when the bike is loaded onto the rack, whether the bike is secured in the rack, and accessory parameters of the bike (e.g., size, shape, weight, whether it is one of a plurality of bikes, etc.) and adjust operation of the mobile device 102 accordingly.

It will be appreciated that the operation of the mobile device 102 may be controlled based on a myriad of other mobile device accessory conditions and scenarios. Overall, the presently disclosed technology provides mobile device accessory management, such that operation of a particular mobile device is dynamically controlled based on an accessory profile and an attachment state of a particular mobile device accessory.

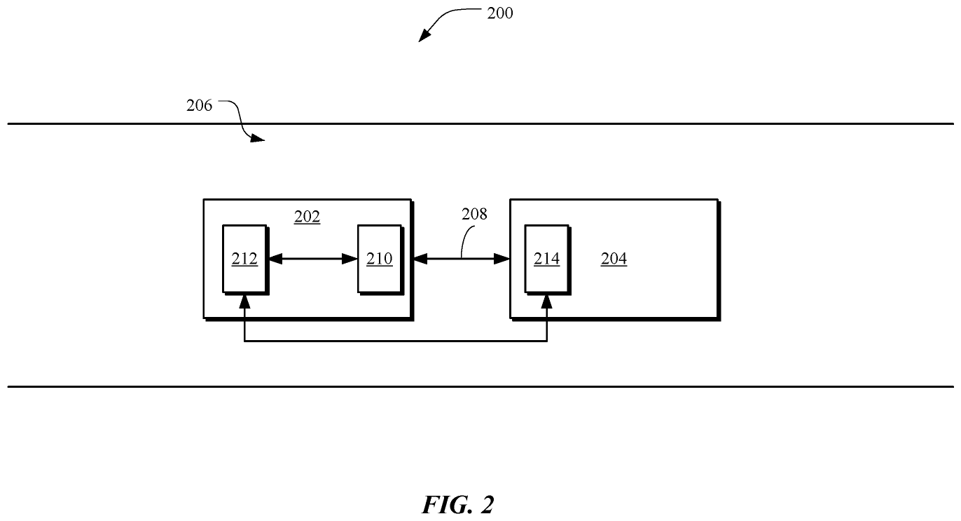

Turning to FIG. 2, an example environment 200 for mobile device accessory management is shown. In one implementation, one or more mobile device accessories (e.g., a mobile device accessory 204) are used in connection with a mobile device 202. The mobile device 202 may be similar to the mobile device 102, and the mobile device accessory 204 may be similar to the mobile device accessory 106 in some examples. The mobile device accessory 204 may be: attached to the mobile device 202, moving in connection with the mobile device 202, and/or otherwise associated with the mobile device 202. In some examples, the mobile device 202 is attached to the mobile device accessory 204, either directly or indirectly, using an attachment system 208. For example, the mobile device accessory 204 may be bolted, welded, tethered, jointed (e.g., using a ball joint), mounted, releasably connected, and/or the like to the mobile device 202. The attachment system 208 may be a magnetic system using one or more magnets. For example, the mobile device accessory 204 and/or the mobile device 202 may include a magnet that releasably attaches the mobile device accessory 204 to the mobile device 202 using a magnetic field.

In one implementation, the mobile device 202 is configured to move along a movement path 206 (e.g., a route, movement trajectory, travel path, etc.) from a first location (e.g., an origin) towards a second location (e.g., a destination). In one example, the mobile device 202 may be capable of operating to move along the movement path 206 through a series of route and motion planning decisions made and taken by the mobile device 202, as described herein.

A monitoring system 212 may be in communication with a sensor system, via wired and/or wireless communication, for monitoring the mobile device accessory 204 in connection with movement along the movement path 206. The sensor system may include one or more sub-sensor systems (e.g., a sensor system 210, a sensor system 214, etc.). The monitoring system 212 and/or the sensor system may be part of the mobile device 202, the mobile device accessory 204, other devices, and/or a combination thereof. The sensor system 210 may include one or more sensors configured to capture accessory data associated with the mobile device accessory 204. For example, the sensor system 210 may include a two-dimensional (2D) sensor, such as a camera, for receiving visual imagery associated with the mobile device accessory 204. The sensor system 210 may include one or more 3D sensors, such as light detection and ranging (LIDAR), sound navigation and ranging (SONAR), radio detection and ranging (RADAR), or any combination thereof, for receiving any spacial context associated with the mobile device accessory 204. For example, the spacial context associated with the mobile device accessory 204 may include a distance of the mobile device accessory 204 to the mobile device 202, which may be determined using RADAR. The sensor system 210 may further include a microphone for capturing an audible context associated with the mobile device accessory 204; thermal sensors configured to detect a temperature of the mobile device accessory, and/or the like. The accessory data may be captured and processed in real-time, near to real-time, or may be delayed in some cases. While various example sensors are described to facilitate understanding of the presently disclosed technology, it will be appreciated that any suitable sensor or sensors of the same or different types may be used to capture accessory data associated with the mobile device accessory 204 and/or the movement of the mobile device 202 and the mobile device accessory 204 along the movement path 206.

In some implementations, the monitoring device 212 may be communicably coupled to the sensor system 214 that is disposed on or otherwise associated with the mobile device accessory 204. For instance, the sensor system 214 may include one or more sensors configured to measure operational values of the mobile device accessory 204, such as pressure (e.g., tire pressure), temperature, system values (e.g., standard operational ranges, etc.), and/or the like. The sensor system 210 and/or the sensor system 214 may include an accelerometer for detecting vibrations of the mobile device accessory 204, a gyroscope for detecting an orientation and/or leveling of the mobile device accessory 204. Using the accessory data, the monitoring system 212 identifies an event affecting mobile device operation of the mobile device 202, accessory operation of the mobile device accessory 204, and/or one or more objects along the movement path 206. A response to the event is determined. In some examples, the monitoring system 212 is associated with the mobile device 202, such that the mobile device 202 both captures the accessory data for identifying the event and performs the response to the event. The accessory data may correspond to the mobile device accessory 204 and/or the mobile device 202 (such that changes in state of the mobile device accessory 204 may be inferred based on a change in behavior of the mobile device 202). In these examples, additional sensors and/or monitoring devices, such as the sensor system 214, may be eliminated.

The event may be identified based on a change in accessory state for the mobile device accessory 204 in connection with the movement along the movement path 206. In one implementation, the monitoring system 212 may identify the event by detecting a change in behavior of the mobile device accessory 204 relative to an expected behavior. The change in behavior may be determined based on the accessory data, and in some cases, further based on additional information regarding the mobile device accessory 204. As one non-limiting example, the monitoring system 212 may identify the event by determining whether a change in tilt associated with the mobile device accessory 204 has increased over a baseline (e.g., expected) level of tilt of the mobile device accessory 204. The monitoring system 212 may consider historical observations, such as movement, vibration, and speed of change in behavior of the mobile device accessory 204. The monitoring system 212 may compare the accessory data to a threshold to identify whether a change in behavior warranting a response has occurred. For example, if the vibration of the accessory increases over a threshold, the monitoring system 212 may determine and trigger a particular response. In some cases, multiple thresholds may be used in connection with a graduating response. For example, if the vibration increases over a first threshold, a first response may be triggered (e.g., a notification to a user), and if the vibration increases over a second threshold greater than the first threshold, a second response may be triggered (e.g., robotic action to stop movement of the mobile device 202).

Additionally or alternatively, predefined characteristics may be considered, such as a level, orientation, size, range of motion, and/or the like associated with the mobile device accessory 204. As an example, if a level of the mobile device accessory 204 changes (e.g., the mobile device accessory 204 tilts) more than a threshold amount, a particular response may be triggered. Similarly, situation changes may be detected, such as a change in color, a change in temperature, presence of an external object or condition (e.g., debris, etc.), change in shape, change in distribution of weight, change in composition (e.g., gas, etc.), and/or the like. As such, the accessory data may generally be used to determine a behavior of the mobile device 202 and/or the mobile device accessory 204 in connection with movement along the movement path 204, which may include a movement, appearance, one or more values, attachment state, and/or the like, and compare that with an expected behavior of the mobile device 202 and/or the mobile device accessory 204 during motion.

Generally, an event may be identified by determining a change between a first accessory state of the mobile device accessory 204 and a second accessory state of the mobile device accessory 204. The change in accessory states may be determine by observing a behavior of the mobile device accessory 204 during movement along the movement path 206 relative to an expected behavior of the mobile device 204 during motion. In some examples, the change in accessory states may be inferred by observing a behavior of the mobile device 202 during movement along the movement path 206 relative to an expected behavior of the mobile device 202 while attached to the mobile device accessory 204 during motion. In determining the change in accessory states, the monitoring device 212 may analyze the accessory data in various manners, such as using one or more thresholds, ranges, profiles, values, behavior models, machine learning, artificial intelligence, and/or the like. For example, an event of a deflating tire may be detected based on a change in a level measured using an on-device sensor, detected based on visual tilting captured using a camera, and/or the like.

In some cases, the monitoring system 212 may be configured to indicate a priority level to a particular event. The priority level may be a plurality of priority levels corresponding to a graduating response of a plurality of responses that escalate or deescalate from prior responses. For example, events with a lower priority may correspond to maintenance type events and events with a higher priority may correspond to movement type events. Generally, movement type events may correspond to events in which the movement along the movement path is affected. Maintenance type events may correspond to events that are within a predetermined level of change between the accessory states. In some instances, multiple occurrences of a same type of event may escalate the response and/or otherwise assign a higher priority level.

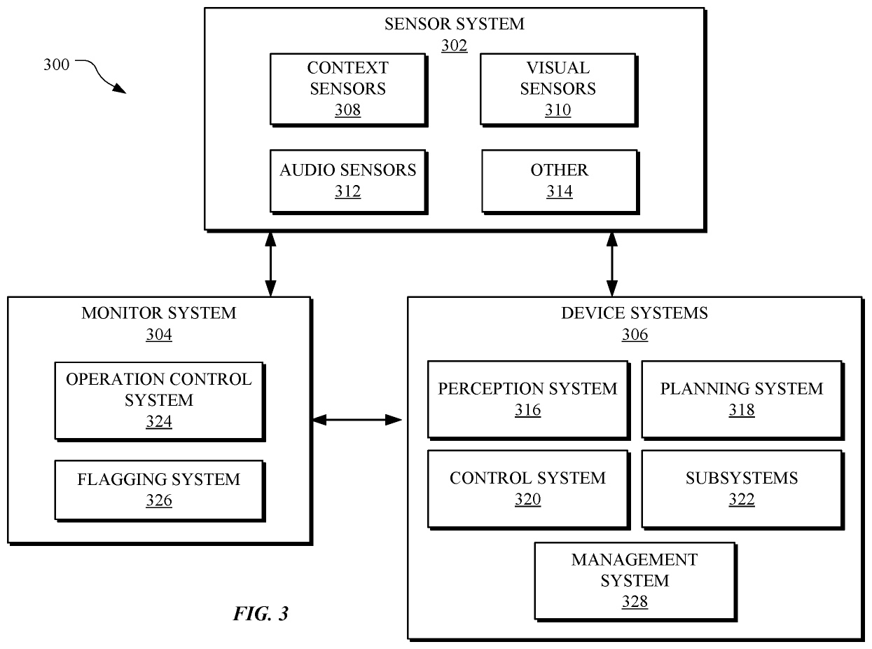

Referring to FIG. 3, Turning to FIG. 3, an example mobile device 300, which may be the mobile device 102, the mobile device 202 or other mobile devices, is shown. In one implementation, the mobile device 300 is associated with a sensor system 302, a monitoring system 304, and device systems 306. The sensor system 302 and/or the monitoring system 304 may be part of or separate from but in communication with the mobile device 300, the sensor system 302, and/or the device systems 306. It will be appreciated that any of a perception system 316, a planning system 318, a control system 320, subsystems 322, and/or a management system 328 may be part of or separate from the device systems 306. In some instances, the management system 328 may be the accessory management system 108. In other instances, the management system 328 may be in communication with the accessory management system 108. Similarly, an operation control system 324, a flagging system 326 may be part of or separate from the monitoring system 304. The systems 302-328 may generally be separate components, integrated components, or combinations thereof.

The sensor system 302 has one or more sensors configured to capture sensor data of a field of view of the mobile device 300, such as one or more images, localization data corresponding to a location, heading, orientation, and/or the like of the mobile device 200, movement data corresponding to motion of the mobile device 200, and/or the like. The sensor system 302 may further capture accessory data corresponding to movement of the mobile device accessory 204 along the movement path 206. For example, the one or more sensors may include context sensor(s) 308, such as one or more three-dimensional (3D) sensors configured to capture 3D images, RADAR sensors, SONAR sensors, infrared (IR) sensors, optical sensors, visual detection and ranging (VIDAR) sensors, and/or the like. The one or more 3D sensors may include one or more LIDAR sensors (e.g., scanning LIDAR sensors) or other depth sensors.

The sensor system 302 may further include one or more visual sensors 310, such as cameras (e.g., RGB cameras). The cameras may capture color images, grayscale images, and/or other 3D images. One or more audio sensors 312 such as microphones may capture audio data. Other sensors 314 may be implemented as suitable for capturing the accessory data and/or other information regarding the behavior of the mobile device accessory 104, such as temperature, pressure, composition, and/or other values. The other sensors 314 may further include, without limitation, global navigation satellite system (GNSS), inertial navigation system (INS), inertial measurement unit (IMU), global positioning system (GPS), altitude and heading reference system (AHRS), compass, accelerometer, and/or other localization systems.

In some examples, the perception system 316 generates perception data, which may detect, identify, classify, and/or determine position of one or more objects using the sensor data. The perception data may include the accessory data for obtaining the accessory profile 110, the attachment state, the accessory state, and/or the like. The perception data may further be used by the planning system 318 in generating one or more actions for the mobile device 300, such as generating a motion plan having at least one movement action for autonomously moving the mobile device 300 through a scene based on the presence of objects and according to the accessory profile 110, the attachment state, and/or the accessory state. The control system 318 may be used to control various operations of the mobile device 300 in executing the motion plan. The motion plan may include various operational instructions for subsystems 322 of the mobile device 300 to autonomously execute to perform the movement action(s), as well as other action(s).

In some examples, the perception system 316 generates perception data, which may be used to determine the accessory state of the mobile device accessory 204. The perception data may include or otherwise be generated based on the accessory data. The perception data may be used by the monitoring system 304 to identify an event and determine one or more responses to the event. The monitoring system 304 may trigger the response using an operation control system 324, a flagging system 326, and/or the like. For example, the operation control system may trigger one or more actions for performance by the mobile device 300 and/or the mobile device accessory 104. The flagging system 326 may flag the event. The monitoring system 304 may further trigger the response through communication with a remote device over a network, a user device, and/or the like.

The planning system 318 may generate instructions corresponding to the one or more actions for the mobile device 300 for performing the one or more responses to the event. For example, the instructions may include a motion plan having at least one movement action for autonomously moving the mobile device 300 to perform the response. The control system 318 may be used to control various operations of the mobile device 300 in executing the motion plan. The motion plan may include various operational instructions for subsystems 322 of the mobile device 300 to execute for performing the response.

In a non-limiting example, the mobile device 300 may be towing the mobile device accessory 204 in the form of a trailer, which has a tire on a first side that experiences a loss of pressure. Due to the loss of pressure, the mobile device accessory 104 may lean towards the first side by a percentage tilt. The visual sensors 310 may detect the percentage tilt, and the monitoring system 304 may compare the percentage tilt to a threshold tilt. If the percentage tilt exceeds the threshold tilt, an event relating to a deflated tire may be detected and a response determined accordingly (e.g., slow or stop movement, contact a remote device, notify one or more occupants, etc.). Other sensors may be similarly used to detect such an event. For example, the event may be inferred based on additional rolling resistance based on speed load. As another example, if the loss of pressure is immediate, the audio sensors 312 may capture a sound matching a model for such events.

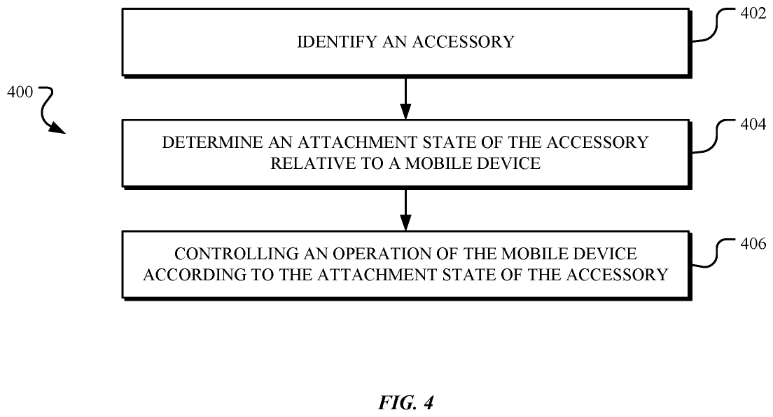

Referring to FIG. 4, example operations 400 for mobile device accessory management are illustrated. In one implementation, an operation 402 identifies a mobile device accessory. The mobile device accessory is associated with a mobile device configured to move on its own planning and decisions from a first location towards a second location. The operation 402 may include identifying a presence of the mobile device accessory and obtaining the accessory profile. In one implementation, the accessory profile is obtained using a visual identifier, a transmitted identifier, and/or the like. The visual identifier may include a QR code, for example. The accessory profile may be obtained in response to scanning a visual identifier with a camera, which may be associated with a user device, the mobile device, and/or a computing device. The accessory profile may be generated using accessory data corresponding to the mobile device accessory, with the accessory data being captured using one or more sensors.

An operation 404 determines an attachment state of the mobile device accessory relative to the mobile device. The attachment state may be detected using accessory data captured using one or more sensors. In one implementation, the attachment state is determined at one or more times. The one or more times may include, without limitation, a first time prior to the mobile device moving from the first location to the second location, a second time while the mobile device is moving from the first location to the second location, and/or the like. The attachment state and/or the accessory profile may be communicated to a user device or other computing device (e.g., a smartphone, display in or associated with the mobile device and/or the mobile device accessory, etc.).

An operation 406 controls an operation of the mobile device according to the attachment state of the mobile device accessory. In one implementation, the operation of the mobile device is adjusted based on an accessory profile corresponding to the mobile device accessory. For example, operation 406 may adjust an operation of the mobile device based on the accessory profile when the attachment state is identified as attached, and the operation 406 may forgo adjustment of the operation of the mobile device when the attachment state is identified as unattached. The operation of the mobile device may include turning, sensor alarm activation, reversing, external vision, acceleration, deceleration, navigation, and/or the like. Additionally, the operation 406 may comprise controlling accessory operation of the mobile device accessory.

In one example, the operation includes a turning operation, where the turning operation is performed in accordance with a turning radius determined based on the accessory profile. The turning operation may include, without limitation, a three-point turn, a U-turn, or other turns. In another example, the operation of the mobile device includes a deceleration operation. The deceleration operation may be performed in accordance with a rate of deceleration, a stopping distance, and/or the like determined based on the accessory profile. In another example, the operation of the mobile device includes clearance operation. The clearance operation may comprise generating a route based on the accessory profile. The route has a vertical clearance that exceeds a vertical height of the mobile device accessory, as well as any load as determined based on the accessory state.

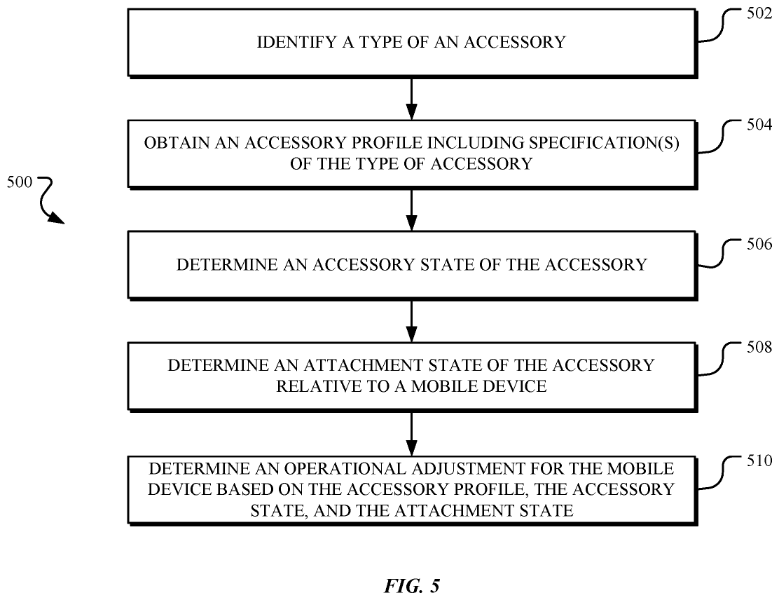

Turning to FIG. 5, example operations 500 for mobile device accessory management are illustrated. In one implementation, an operation 502 identifies a type of a mobile device accessory. The type of the mobile device accessory may be identified using accessory data, user input, and/or the like. An operation 504 obtains an accessory profile including one or more specifications for the type of the mobile device accessory. An operation 506 determines an accessory state of the mobile device accessory (e.g., based on the accessory profile), and an operation 508 determines an attachment state of the mobile device accessory relative to a mobile device. An operation 510 determines an operational adjustment for the mobile device based on the accessory state, the attachment state, and the accessory profile.

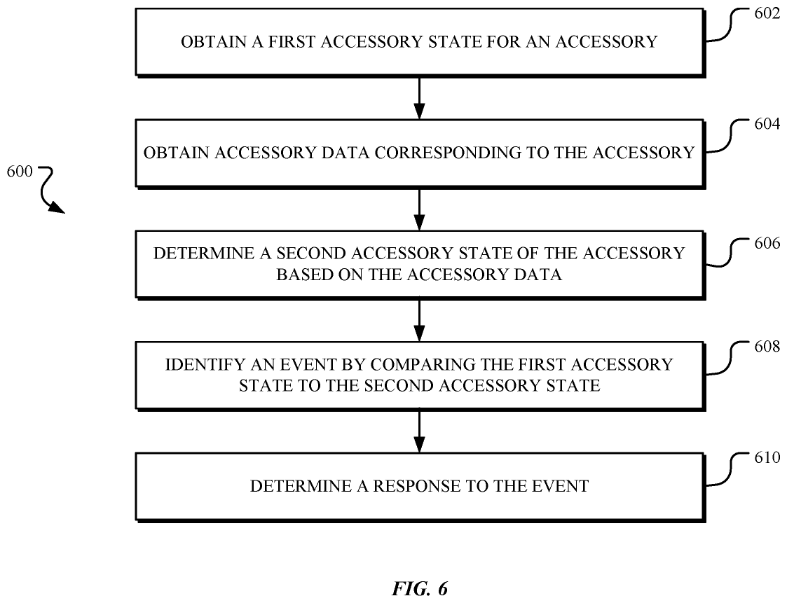

FIG. 6 illustrates example operations 600 for mobile device accessory management. In one implementation, an operation 602 obtains a first accessory state for a mobile device accessory. The first accessory state may correspond to an expected behavior of the mobile device accessory during motion. For example, the expected behavior may include an expected movement, an expected appearance, one or more expected values, an expected attachment state, and/or the like. The expected movement may include, without limitation, range of motion, flow of motion, vibration level, speed of change, level of external motion (e.g., caused by debris), and/or the like. The expected appearance includes, but is not limited to, levelling (e.g., relative levels of points along a plane), orientation, size, shape, texture, color, and/or the like. The expected values may include, without limitation, temperature, pressure, composition, subsystem operational values of the mobile device or the mobile device accessory, and/or the like.

An operation 604 obtains accessory data corresponding to the mobile device accessory. The accessory data captured in connection with movement along a movement path from a first location towards a second location. For example, the accessory data may be captured at the first location, along the movement path, at the second location, before the movement, during the movement, after the movement, and/or the like. The mobile device accessory may be attached to a mobile device, moving along the movement path with the mobile device, and/or otherwise be associated with movement of the mobile device. The accessory data may be captured using one or more sensors. The sensors may form part of or otherwise be associated with the mobile device, the mobile device accessory, and/or another computing device (e.g., a removable computing device deployed to monitor the mobile device accessory). The sensors may include, without limitation, depth, LIDAR, camera, sonar, radar, microphone, infrared, thermal, and/or the like.

An operation 606 determines a second accessory state of the mobile device accessory based on the accessory data. The second accessory state may correspond to a behavior of the mobile device accessory in connection with the movement. The behavior of the mobile device accessory in connection with the movement may include, without limitation, movement, appearance, one or more values, attachment state, and/or the like. An operation 608 identifies an event affecting at least one of mobile device operation of the mobile device or accessory operation of the mobile device accessory. In one implementation, the operation 608 compares the expected behavior of the mobile device accessory to the behavior of the mobile device accessory.

An operation 610 determines a response to the event. The response may be performed by the mobile device, the mobile device accessory, a remote device, a user device, and/or the like. In some examples, the response includes, without limitation: controlling the mobile device operation; controlling the mobile device accessory operation; flagging the event; prompting manual control of the mobile device; sending a communication to a remote device; initiating remote control of the mobile device and/or the mobile device accessory; deployment of a second mobile device to a location of the mobile device (e.g., a current location or predicted future location), scheduling maintenance, and/or the like. Deployment of the second mobile device may involve deploying one or more resources for addressing or resolving the event.

In one implementation, an event type of the event is determined, and the response is determined based on the event type. The event type may be a movement type event, a maintenance type event, and/or the like. Generally, movement type events may correspond to events in which the movement along the movement path is affected. Maintenance type events may correspond to events that are within a predetermined level of change between the first accessory state and the second accessory state. The predetermine level of change may be visually based, audially based, value based (e.g., pressure value, temperature value, composition value, etc.), and/or the like. In some examples, the movement along the movement path is permitted or can otherwise continue in view of a maintenance type event.

When the event type is a movement type event, the response may include controlling the mobile device operation and/or the accessory operation. For example, controlling the mobile device operation may include, without limitation: adjusting the movement path (e.g., exiting the movement path, rerouting the movement path, etc.); slowing the movement; stopping the movement; adjusting a parameter of the movement (e.g., speed, turning, etc.); adjusting a subsystem (e.g., lights, brakes, gear shifting, external communication, planning, etc.); and/or the like. Similarly, controlling the accessory operation may include, without limitation: adjusting a parameter of the movement of the mobile device accessory; adjusting the movement path of the accessory relative to the mobile device; adjusting an attachment state of the mobile device accessory to the mobile device; adjusting a subsystem; ceasing one or more operations of the mobile device accessory; and/or the like.

When the event type is a maintenance type event, the response may include flagging the event. For example, flagging the event may include generating an alert, recording information corresponding to the event in a log (e.g., a diagnostic log), and/or the like. The alert may be sent to the mobile device, a user device, and/or a remote device. The alert may be presented using a presentation system. The presentation system may display the alert visually, play the alert audially, and/or using tactile feedback. The alert may prompt an action, such as scheduling maintenance, deployment of resources, generating recommendations for addressing the event, and/or the like.

In one implementation, the response is a graduating response of a plurality of responses. A plurality of accessory states may be determined in connection with the movement along the movement path. Based on any changes between states, subsequent responses may escalate or deescalate previous responses. For example, a second response escalating the response may be determined based on a change from the second accessory state to a third accessory state. Accordingly, for each event and/or state change, a priority level may be assigned, with the response tailored accordingly.

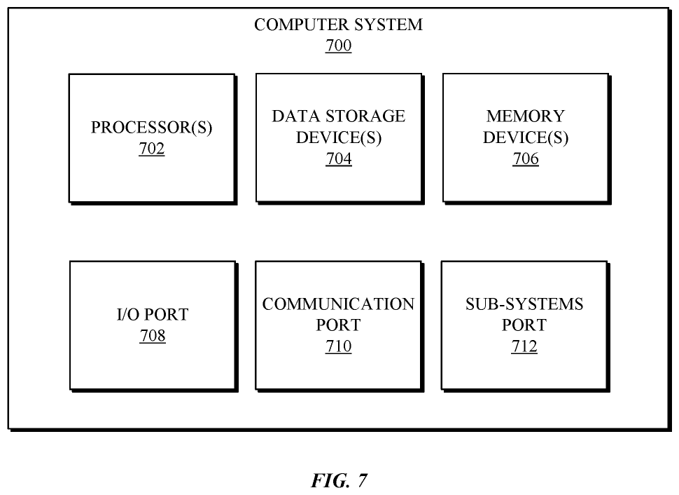

FIG. 7 illustrates an example computing system 700 having one or more computing units that may implement various systems and methods discussed herein. The computing system 700 may be applicable to the mobile device 102, the mobile device accessory 106, the accessory management system 108, the mobile device 202, the mobile device accessory 204, the monitoring system 304, the device systems 306, the management system 328, and other computing or network devices. It will be appreciated that specific implementations of these devices may be of differing possible specific computing architectures not all of which are specifically discussed herein but will be understood by those of ordinary skill in the art.

The computing system 700 may be a computing system capable of executing a computer program product to execute a computer process. Data and program files may be input to the computing system 700, which reads the files and executes the programs therein. Some of the elements of the computing system 700 are shown in FIG. 7, including one or more hardware processors 702, one or more data storage devices 704, one or more memory devices 706, and/or one or more ports 708, 710, 712. Additionally, other elements that will be recognized by those skilled in the art may be included in the computing system 700 but are not explicitly depicted in FIG. 7 or discussed further herein. Various elements of the computing system 700 may communicate with one another by way of one or more communication buses, point-to-point communication paths, or other communication means not explicitly depicted in FIG. 7.

The processor 702 may include, for example, a central processing unit (CPU), a microprocessor, a microcontroller, a digital signal processor (DSP), and/or one or more internal levels of cache. There may be one or more processors 702, such that the processor 702 comprises a single central-processing unit, or a plurality of processing units capable of executing instructions and performing operations in parallel with each other, commonly referred to as a parallel processing environment.

The computing system 700 may be a conventional computer, a distributed computer, or any other type of computer, such as one or more external computers made available via a cloud computing architecture. The presently described technology is optionally implemented in software stored on the data storage device(s) 704, stored on the memory device(s) 706 (e.g., one or more tangible non-transitory computer-readable storage media), and/or communicated via one or more of the ports 708, 710, 712, thereby transforming the computing system 700 in FIG. 7 to a special purpose machine for implementing the operations described herein. Examples of the computing system 700 include personal computers, servers, purpose-built autonomy processors, terminals, workstations, mobile phones, tablets, laptops, and the like.

The one or more data storage devices 704 may include any non-volatile data storage device capable of storing data generated or employed within the computing system 700, such as computer executable instructions for performing a computer process, which may include instructions of both application programs and an operating system (OS) that manages the various components of the computing system 700. The data storage devices 704 may include, without limitation, magnetic disk drives, optical disk drives, solid state drives (SSDs), flash drives, and the like. The data storage devices 704 may include removable data storage media, non-removable data storage media, and/or external storage devices made available via a wired or wireless network architecture with such computer program products, including one or more database management products, web server products, application server products, and/or other additional software components. Examples of removable data storage media include Compact Disc Read-Only Memory (CD-ROM), Digital Versatile Disc Read-Only Memory (DVD-ROM), magneto-optical disks, flash drives, and the like. Examples of non-removable data storage media include internal magnetic hard disks, SSDs, and the like. The one or more memory devices 706 may include volatile memory (e.g., dynamic random-access memory (DRAM), static random-access memory (SRAM), etc.) and/or non-volatile memory (e.g., read-only memory (ROM), flash memory, etc.).

Computer program products containing mechanisms to effectuate the systems and methods in accordance with the presently described technology may reside in the data storage devices 704 and/or the memory devices 706, which may be referred to as machine-readable media. It will be appreciated that machine-readable media may include any tangible non-transitory medium that is capable of storing or encoding instructions to perform any one or more of the operations of the present disclosure for execution by a machine or that is capable of storing or encoding data structures and/or modules utilized by or associated with such instructions. Machine-readable media may include a single medium or multiple media (e.g., a centralized or distributed database, and/or associated caches and servers) that store the one or more executable instructions or data structures.

In some implementations, the computing system 700 includes one or more ports, such as an input/output (I/O) port 708, a communication port 710, and a sub-systems port 712, for communicating with other computing, network, or vehicle devices. It will be appreciated that the ports 708-712 may be combined or separate and that more or fewer ports may be included in the computing system 700.

The I/O port 708 may be connected to an I/O device, or other device, by which information is input to or output from the computing system 700. Such I/O devices may include, without limitation, one or more input devices, output devices, and/or environment transducer devices.

In one implementation, the input devices convert a human-generated signal, such as, human voice, physical movement, physical touch or pressure, and/or the like, into electrical signals as input data into the computing system 700 via the I/O port 708. Similarly, the output devices may convert electrical signals received from computing system 700 via the I/O port 708 into signals that may be sensed as output by a human, such as sound, light, and/or touch. The input device may be an alphanumeric input device, including alphanumeric and other keys for communicating information and/or command selections to the processor 702 via the I/O port 708. The input device may be another type of user input device including, but not limited to: direction and selection control devices, such as a mouse, a trackball, cursor direction keys, a joystick, and/or a wheel; one or more sensors, such as a camera, a microphone, a positional sensor, an orientation sensor, a gravitational sensor, an inertial sensor, and/or an accelerometer; and/or a touch-sensitive display screen (“touchscreen”). The output devices may include, without limitation, a display, a touchscreen, a speaker, a tactile and/or haptic output device, and/or the like. In some implementations, the input device and the output device may be the same device, for example, in the case of a touchscreen.

The environment transducer devices convert one form of energy or signal into another for input into or output from the computing system 700 via the I/O port 708. For example, an electrical signal generated within the computing system 700 may be converted to another type of signal, and/or vice-versa. In one implementation, the environment transducer devices sense characteristics or aspects of an environment local to or remote from the computing system 700, such as, light, sound, temperature, pressure, magnetic field, electric field, chemical properties, physical movement, orientation, acceleration, gravity, and/or the like. Further, the environment transducer devices may generate signals to impose some effect on the environment either local to or remote from the example computing system 700, such as, physical movement of some object (e.g., a mechanical actuator), heating or cooling of a substance, adding a chemical substance, and/or the like.

In one implementation, a communication port 710 is connected to a network by way of which the computing system 700 may receive network data useful in executing the methods and systems set out herein as well as transmitting information and network configuration changes determined thereby. Stated differently, the communication port 710 connects the computing system 700 to one or more communication interface devices configured to transmit and/or receive information between the computing system 700 and other devices by way of one or more wired or wireless communication networks or connections. Examples of such networks or connections include, without limitation, Universal Serial Bus (USB), Ethernet, Wi-Fi, Bluetooth®, Near Field Communication (NFC), cellular, and so on. One or more such communication interface devices may be utilized via the communication port 710 to communicate one or more other machines, either directly over a point-to-point communication path, over a wide area network (WAN) (e.g., the Internet), over a local area network (LAN), over a cellular (e.g., third generation (3G), fourth generation (4G) network, or fifth generation (5G)), network, or over another communication means. Further, the communication port 710 may communicate with an antenna for electromagnetic signal transmission and/or reception. In some examples, an antenna may be employed to receive Global Positioning System (GPS) data to facilitate determination of a location of a machine, vehicle, or another device.

In some examples, the mobile devices (e.g., 102, 202) described herein are a vehicle, and the mobile device accessories (e.g., 104, 206) is a vehicle accessory. The computing system 700 may include a sub-systems port 712 for communicating with one or more systems related to a vehicle to control an operation of the vehicle and/or exchange information between the computing system 700 and one or more sub-systems of the vehicle. Examples of such sub-systems of a vehicle, include, without limitation, imaging systems, radar, LIDAR, motor controllers and systems, battery control, fuel cell or other energy storage systems or controls in the case of such vehicles with hybrid or electric motor systems, autonomous or semi-autonomous processors and controllers, steering systems, brake systems, light systems, navigation systems, environment controls, entertainment systems, and the like.

Entities implementing the present technologies should comply with established privacy policies and/or practices. These privacy policies and practices should meet or exceed industry or governmental requirements for maintaining the privacy and security of personal data. Moreover, users should be allowed to “opt in” or “opt out” of allowing a mobile device to participate in such services. Third parties can evaluate these implementers to certify their adherence to established privacy policies and practices.

The system set forth in FIG. 7 is but one possible example of a computing system that may employ or be configured in accordance with aspects of the present disclosure. It will be appreciated that other non-transitory tangible computer-readable storage media storing computer-executable instructions for implementing the presently disclosed technology on a computing system may be utilized.

In the present disclosure, the methods disclosed may be implemented as sets of instructions or software readable by a device. Further, it is understood that the specific order or hierarchy of steps in the methods disclosed are instances of example approaches. Based upon design preferences, it is understood that the specific order or hierarchy of steps in the method can be rearranged while remaining within the disclosed subject matter. The accompanying method claims present elements of the various steps in a sample order and are not necessarily meant to be limited to the specific order or hierarchy presented. The described disclosure may be provided as a computer program product, or software, that may include a non-transitory machine-readable medium having stored thereon instructions, which may be used to program a computing system (or other electronic devices) to perform a process according to the present disclosure. A machine-readable medium includes any mechanism for storing information in a form (e.g., software, processing application) readable by a machine (e.g., a computer).

While the present disclosure has been described with reference to various implementations, it will be understood that these implementations are illustrative and that the scope of the present disclosure is not limited to them. Many variations, modifications, additions, and improvements are possible. More generally, aspects in accordance with the present disclosure have been described in the context of particular implementations. Functionality may be separated or combined in blocks differently in various aspects of the disclosure or described with different terminology. These and other variations, modifications, additions, and improvements may fall within the scope of the disclosure as defined in the claims that follow.

What is claimed is:

1. One or more tangible non-transitory computer-readable storage media storing computer-executable instructions for performing a computer process on a computing system, the computer process comprising:
obtaining a first accessory state for a mobile device accessory, the first accessory state corresponding to an expected behavior of the mobile device accessory during motion;
obtaining accessory data corresponding to the mobile device accessory, the accessory data captured in connection with movement along a movement path from a first location towards a second location, the mobile device accessory attached to a mobile device;
determining a second accessory state of the mobile device accessory based on the accessory data, the second accessory state corresponding to a behavior of the mobile device accessory in connection with the movement;
identifying an event affecting at least one of mobile device operation of the mobile device or accessory operation of the mobile device accessory by comparing the expected behavior of the mobile device accessory to the behavior of the mobile device accessory; and
determining a response to the event.

2. The one or more tangible non-transitory computer-readable storage media of claim 1, further comprising:
determining an event type of the event, the response being determined based on the event type.

3. The one or more tangible non-transitory computer-readable storage media of claim 2, wherein the response includes controlling at least one of the mobile device operation or the accessory operation when the event type is a movement type event, the movement type event corresponding to the movement being affected by the event.

4. The one or more tangible non-transitory computer-readable storage media of claim 3, wherein controlling the mobile device operation includes adjusting the movement path.

5. The one or more tangible non-transitory computer-readable storage media of claim 3, wherein controlling the accessory operation includes ceasing one or more operations of the mobile device accessory.

6. The one or more tangible non-transitory computer-readable storage media of claim 3, wherein controlling the mobile device operation includes at least one of slowing or stopping the movement.

7. The one or more tangible non-transitory computer-readable storage media of claim 2, wherein the response includes flagging the event when the event type is a maintenance type event, the maintenance type event being within a predetermined level of change between the first accessory state and the second accessory state.

8. The one or more tangible non-transitory computer-readable storage media of claim 7, wherein flagging the event includes generating an alert, the alert being sent to at least one of the mobile device, a user device, or a remote device.

9. The one or more tangible non-transitory computer-readable storage media of claim 8, wherein flagging the event includes recording information corresponding to the event in a log.

10. A method for mobile device accessory management, the method comprising:
obtaining a first accessory state for a mobile device accessory, the first accessory state corresponding to an expected behavior of the mobile device accessory during motion;
obtaining accessory data corresponding to the mobile device accessory, the accessory data captured in connection with movement along a movement path from a first location towards a second location, the mobile device accessory moving along the movement path with a mobile device;
determining a second accessory state of the mobile device accessory based on the accessory data, the second accessory state corresponding to a behavior of the mobile device accessory in connection with the movement;
identifying an event affecting at least one of mobile device operation of the mobile device or accessory operation of the mobile device accessory by comparing the expected behavior of the mobile device accessory to the behavior of the mobile device accessory; and
determining a response to the event.

11. The method of claim 10, wherein the response includes sending a communication to a remote device.

12. The method of claim 11, wherein the communication triggers at least one of control of the mobile device operation by the remote device or deployment of a second mobile device to a location of the mobile device.

13. The method of claim 10, wherein the expected behavior includes an expected movement and an expected appearance.

14. The method of claim 13, wherein the expected movement includes one or more of range of motion, flow of motion, vibration level, speed of change, and level of external motion, wherein the expected appearance includes one or more of levelling, orientation, size, shape, texture, and color.

15. The method of claim 10, wherein the expected behavior includes an expected temperature.

16. The method of claim 10, wherein the expected behavior includes an expected attachment state.

17. A system for mobile device accessory management, the system comprising:
one or more sensors configured to capture accessory data corresponding to a mobile device accessory, the accessory data captured in connection with movement along a movement path from a first location towards a second location, the mobile device accessory moving along the movement path with a mobile device;
a monitoring system configured to identify an event affecting at least one of mobile device operation of the mobile device or accessory operation of the mobile device accessory by comparing a first accessory state for the mobile device accessory to a second accessory state for the mobile device accessory, the monitoring system determining a response to the event.

18. The system of claim 17, wherein the mobile device includes the one or more sensors and the response is performed by the mobile device.

19. The system of claim 17, wherein the one or more sensors include at least one of LIDAR, sonar, radar, camera, or microphone.

20. The system of claim 17, wherein the monitoring system determines a second response escalating the response based on a change from the second accessory state to a third accessory state.
